(19) United States
(12) Patent Application Publication
(10) Pub. No.: US 2015/0246455 A1
(43) Pub. Date: Sep. 3, 2015

(54) REMOTE CUTTING TOOL

(71) Applicant: ICOR Technology Inc., Ottawa (CA)

(72) Inventor: Ken Molnar, Greely (CA)

(21) Appl. No.: 13/928,563

(22) Filed: Jun. 27, 2013

(51) Int. Cl. B26B 27/00; A63B 29/02; F16B 45/02

(52) U.S. Cl. CPC B26B 27/00; F16B 45/02; A63B 29/02

(57) ABSTRACT

The invention provides for a lightweight and resilient cutting tool which is usable in situations where a line, rope, wire, or similar object needs to be cut while allowing the operator to remain at a safe distance from the object, and a method for its use. The cutting tool comprises: a rigid frame enclosing an open area, a means for attaching a controlling line, agate means, and at least one blade mounted on the frame relative to the controlling line mount. The gate means is designed to allow the object to be placed in the open area, once the object is placed inside the open area the controlling line can be pulled taut at a safe distance and the object will be pulled against the blade and cut.

### FIELD

The invention concerns afield expedient, lightweight, and resilient cutting tool for use in situations where a line, rope, wire, or similar object needs to be cut while allowing the operator to remain at a safe distance from the object, for example in dealing with defusing, or rendering safe an explosive device.

### BACKGROUND

In disposing of explosive devices an especially high risk to explosives disposal experts and/or bomb disposal robots surrounds cutting lines, ropes, wires or similar objects associated with the device. There is a clear need for a tool by which the expert or robot can cut a target line remotely, thereby minimizing the risk to human lives and expensive equipment posed by the explosive device.

Currently, one example of an explosives disposal operation is as follows: An explosives disposal operator on scene has determined that the best course of action is to cut a wire/trip line/detonation cord as the only course of action. Time is a concern, given the unknown nature of the device and nearby persons. The explosives disposal operator then puts themself in danger by physically going to the device and cutting the wire/trip line/detonation cord knowing full well that any movement or manipulation of the device may make it function.

An ideal tool should be designed in such a way as to be lightweight, easily connectible to the line, rope, wire, or other similar object, and resilient against damage due to an explosion if such occurs

### SUMMARY OF THE INVENTION

The invention provides a field expedient, lightweight, and resilient cutting tool which can be used to out through lines, ropes, wires, and other similar objects from a distance.

In one embodiment, the invention is directed to a cutting tool for remotely cutting a target line. The cutting tool comprises: a rigid frame enclosing an open area; means for attaching a remote controlling line to the frame; gate means located in the frame, said gate means configured for selective opening and placement of the target line in the open area, and for closing to contain the target line in the open area when a pulling force is applied to the remote controlling line; and at least one cutting blade mounted on the frame in a position, set relative to the means for attaching a remote controlling line, for remote cutting of the target line in the open area when a pulling force is applied to the remote controlling line.

In another embodiment, the invention is directed to a kit comprising: the cutting tool described above and a safety block for removably covering the edge of the at least one cutting blade.

In yet another embodiment, the invention is directed to a kit comprising: the cutting tool described above; a safety block for removably covering the edge of the at least one cutting blade; and one or more replacement blades.

In yet another embodiment, the invention is directed to a method of cutting a target line using a cutting tool as described above. The method comprises: attaching a remote controlling line to the frame; opening the gate means; placing the target line inside the open area; closing the gate means; and applying a pulling force to the remote controlling line wherein the pulling force brings the at least one cutting blade into contact with the target line and the target line is cut.

### DESCRIPTION OF THE FIGURES

In drawings of the preferred embodiments of the invention, without limitation:

FIG. 1 depicts a plan view of a remote cutting tool with two blades according to one preferred embodiment of the invention;

FIG. 2 depicts a perspective exploded view of a remote cutting tool substantially similar to that depicted in FIG. 1 according to an alternate preferred embodiment and an optional safety block;

FIG. 3 depicts a plan view of the cutting tool and safety block of FIG. 2 assembled; and

FIG. 4 depicts a plan view of a remote cutting tool with one blade according to another preferred embodiment of the invention.

### DETAILED DESCRIPTION

When used herein, the term “target line” should be understood to refer to a line, rope, wire, or other similar object which the operator of the remote cutting tool desires to cut.

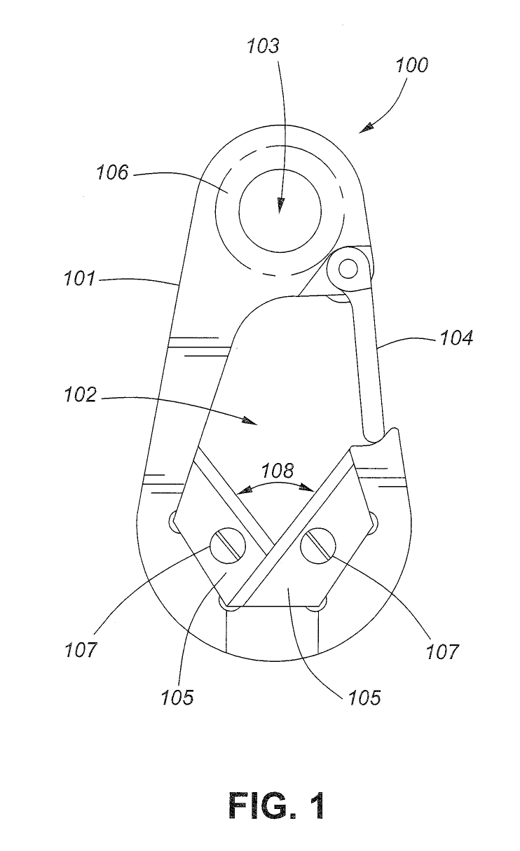

Referring now to the drawings in detail, wherein like numerals indicate like elements throughout, in FIG. 1 the cutting tool 100 is preferably formed of a rigid, e.g. metal or molded plastic, frame 101 which encloses an open area 102. The frame 101, may be in the shape of a carabiner but other shapes may be selected.

The cutting tool 100 further comprises a means for attaching a remote controlling line to the frame 101. FIG. 1 shows the means for attaching a remote controlling line preferably comprises a hole 103 which passes through the frame 101. The hole 103 preferably has a rounded internal surface 106 to reduce abrasion against the controlling line passing through the hole 103 during use of the cutting device 100. The hole 103 and rounded internal surface 106 may be replaced with other means, such as a hook, loop, or cleat. Preferably the means for attaching a remote controlling line allows the controlling line to attach to the frame 101 without passing through the open area 102.

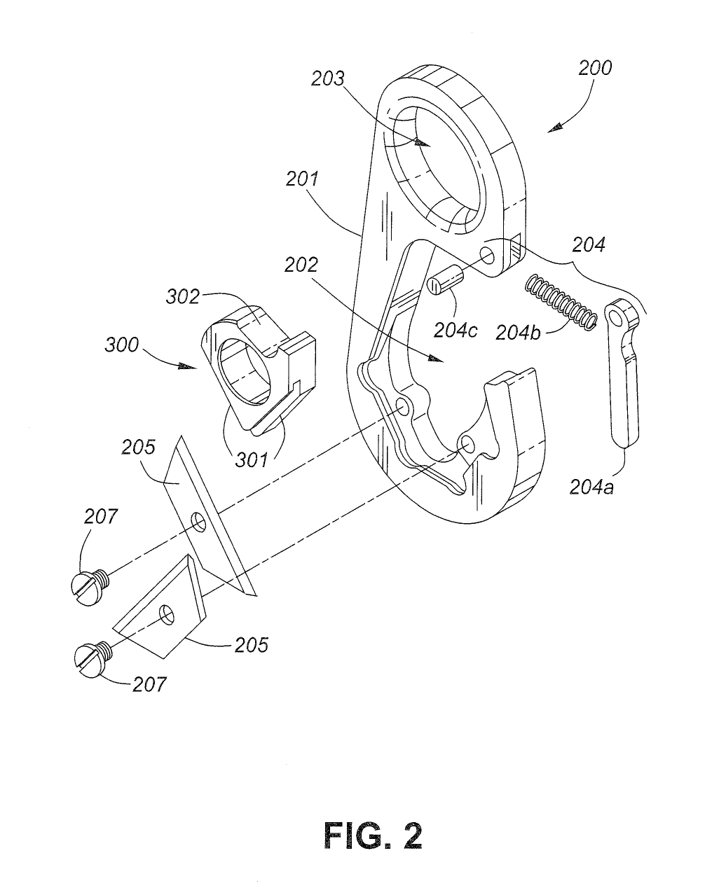

The cutting tool 100 also comprises a gate means 104 located in the frame 101. The gate means 104 is configured for selective opening and closing, allowing a target line to be placed into the open area 102 when the gate means is open and containing the target line in the open area when the gate means 104 is closed. The gate means 104 preferably comprises, as more clearly shown in FIG. 2, a single gate member 204a, a gate biasing means 204b, e.g. a spring, and a pivot 204c. These are consistent with known carabiners, but other gate means are contemplated.

The cutting tool 100 comprises at least one cutting blade 105 which is mounted to the frame 101. The cutting blade 105 is positioned relative to the means for attaching the controlling line so that when a pulling force is applied to the controlling line, the target line will be pulled against the edge of the cutting blade 105, thereby cutting the target line. The cutting blade 105 may be attached to the frame 101 using permanent or removable blade attachment means, shown in FIG. 1 preferably as a pair of screws 107. The cutting blade 105 could also be affixed to the frame 101 using other means known to those skilled in the art, for example using adhesive bonding, rivets, grooves within the frame 101, etc. or the cutting blade 105 may be integrally formed from the frame 101 itself. The cutting blade 105, when preferably removable, permits replacement when damaged, or exchange with another blade having a straight, serrated, or other kind of edge according to the requirements of the target line being cut.

As shown in FIGS. 1 through 3 when using the two cutting blades 105 (or 205) the cutting blades 105 (or 205) may partially overlap and be arranged at an angle 108 from one another to form two cutting surfaces at an angle from one another, i.e. in the v-shaped cutting surfaces shown. The optimum angle 108 between the two cutting surfaces has been found to be between 15° and 90°, depending on the target line, although an angle 108 outside this range may also allow for the invention to operate as intended.

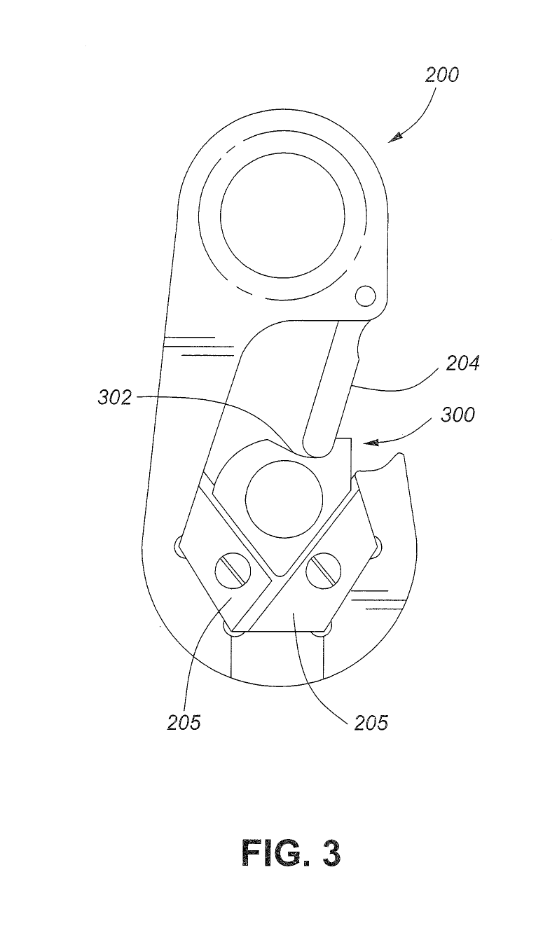

FIG. 2 depicts an alternate cutting tool 200 which is similar to the cutting tool 100 shown in FIG. 1. The exploded view in FIG. 2 allows for a more detailed view of: the frame 201, open area 202, means for attaching a remote controlling line (shown in FIG. 2 as hole 203), gate means 204, cutting blades 205, and blade attachment means 207. Also shown in FIG. 2 is a removable safety block 300 which can be used to cover the edge of the cutting blades 205 when the cutting tool 200 is not in use or is stored. The safety block 300 may optionally comprise at least one groove 301 designed to fit the cutting blades 205 and a gate stop 302 which allows for the use of the gate means 204 to secure the safety block 300 over the edges of the cutting blades 205. FIG. 3 depicts an assembled view of the cutting tool 200 with the safety block 300 in position over the cutting blades 205.

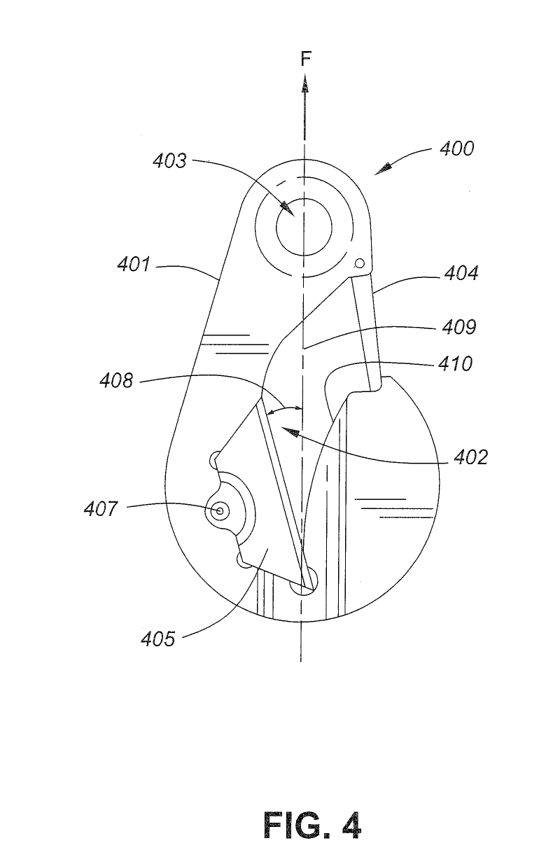

FIG. 4 depicts an alternate cutting tool 400 using a single cutting blade 405 and a modified frame 401. The cutting tool comprises: a frame 401, open area 402, controlling line attachment means 403, gate means 404. The frame 401 has been modified to optimize the cutting tool 400 for supporting a single cutting blade 405. The cutting blade 405 is optimally positioned at an angle 408 between 0° and 70° from a centre line 409 which runs parallel to the direction of the applied pulling force, shown in FIG. 4 as F. The cutting tool 400 may optionally include a guide 410 which acts to direct the target line against the cutting blade 405 when the pulling force is applied. In FIG. 4 the guide 410 is integrally formed from the frame 401, however, it may also be a separate piece designed to fit inside the open area 402 and securely attach to the cutting device 400.

While the cutting tool 100, 200, or 400 of the invention may be sold individually, it may also be packaged as a kit together with a safety block 300 or alternate or replacement cutting blades 105, 205, 405 as appropriate.

For the purpose of describing the functioning of the invention reference will be made to the cutting tool 100 depicted in FIG. 1, although it should be understood that the same method applies for the use of the cutting tools 200 and 400 shown in the other Figures. When in use the cutting tool 100 will be attached to a remote controlling line via the means for attaching a remote controlling line (shown in FIG. 1 as hole 103). The gate means 104 will then be opened and the target line will be placed into the open area 102. The gate means 104 is then closed, securing the target line in the open area 102 and a pulling force is applied to the cutting tool 100 using the remote controlling line once the operator is at a safe distance, The pulling force brings the cutting blade 105 into contact with the target line, thereby cutting the target line.

The cutting tool 100 may also be used for cutting items such as backpacks off of dead or wounded suicide bombers; cutting seatbelts remotely; cutting exposed wires on a device; cutting tripwires; or cutting exposed detonation cord as a few examples.

The invention as claimed is understood not to be limited to the preferred embodiments described above but should be given the broadest possible interpretation consistent with the disclosure of the description as a whole.

1. A cutting tool for remotely cutting a target line, the cutting tool comprising:
a rigid frame enclosing an open area;
means for attaching a remote controlling line to the frame;
gate means located in the frame, said gate means configured for selective opening and placement of the target line in the open area, and for closing to contain the target line in the open area in preparation for cutting; and
at least one cutting blade mounted on the frame in a position set, relative to the means for attaching a remote controlling line, for remote cutting of the target line in the open area when a pulling force is applied to the remote controlling line.

2. The cutting tool of claim 1 wherein the frame is in the shape of a carabiner.

3. The cutting tool of claim 1 wherein the means for attaching a remote controlling line to the frame comprises a hole in the frame.

4. The cutting tool of claim 3 wherein the hole further comprises a rounded internal surface.

5. The cutting tool of claim 1 wherein the at least one cutting blade is removably mounted to the frame.

6. The cutting tool of claim 1 wherein the at least one cutting blade has a straight edge.

7. The cutting tool of claim 1 wherein the at least one cutting blade has a serrated edge.

8. The cutting tool of claim 1 comprising one cutting blade.

9. The cutting tool of claim 8 further comprising a guide for directing the target line against the cutting blade when the pulling force is applied to the remote controlling line.

10. The cutting tool of claim 9 wherein the guide is a part of the frame.

11. The cutting tool of claim 8 wherein an edge of the cutting blade is at an angle of between 0° and 70° from the direction of the pulling force.

12. The cutting tool of claim 1 comprising two cutting blades.

13. The cutting tool of claim 12 wherein the two cutting blades at least partially overlap.

14. The cutting tool of claim 13 wherein the two cutting blades are arranged at an offset angle of between 15° and 90° to one another.

15. The cutting tool of claim 1 wherein the gate means further comprises a gate biasing means to provide a biasing force on the gate means towards the closed position.

16. The cutting tool of claim 1 further comprising a removable safety block which covers the edge of the at least one cutting blade.

17. The cutting tool of claim 15 further comprising a removable safety block which covers the edge of the at least one cutting blade, the safety block comprising a gate stop, the gate means adapted for securing the safety block on the edge of the at least one blade when the gate means is in contact with the gate stop.

18. A kit comprising:
the cutting tool of claim 1; and
a safety block for removably covering the edge of the at least one cutting blade.

19. A kit comprising:
the cutting tool of claim 4;
a safety block for removably covering the edge of the at least one cutting blade; and
one or more replacement cutting blades.

20. A method of cutting a target line using a cutting tool according to claim 1, the method comprising:
attaching a remote controlling line to the frame;
opening the gate means;
placing the target line inside the open area;
closing the gate means; and
applying a pulling force to the remote controlling line wherein the pulling force brings the at least one cutting blade into contact with the target line and the target line is cut.
